(19) United States
(12) Patent Application Publication
(10) Pub. No.: US 2020/0377796 A1
(43) Pub. Date: Dec. 3, 2020

(54) Negative Dielectric Anisotropic Liquid Crystal Compound, Process For Preparing The Same, And Use Thereof

(71) Applicants: Daily-Xianhua Optoelectronics Materials Co., Ltd., Kaohsiung City (TW); Yantai Xianhua Chem-Tech Co., Ltd., Yantai (CN)

(72) Inventors: Tsung-Yu Tsai, Kaohsiung City (TW); Shu-Ling Lo, Kaohsiung City (TW); Meng-Yun Tseng, Kaohsiung City (TW); Zhaochang Luan, Yantai (CN); Peichuan Feng, Yantai (CN)

(73) Assignees: Daily-Xianhua Optoelectronics Materials Co., Ltd., Kaohsiung City (TW); Yantai Xianhua Chem-Tech Co., Ltd., Yantai (CN)

(21) Appl. No.: 16/543,012

(22) Filed: Aug. 16, 2019

(30) Foreign Application Priority Data
May 27, 2019 (TW) 108118248

(51) Int. Cl. C09K 19/30; C09K 19/20

(52) U.S. Cl. CPC C09K 19/3066; C09K 19/20

(57) ABSTRACT

Disclosed is a negative dielectric anisotropic liquid crystal compound represented by Formula (I):

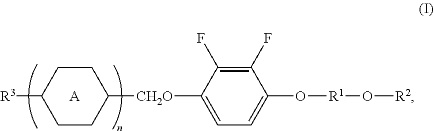

wherein R¹, R², R³,

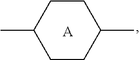

and n are as defined herein. A process for preparing the negative dielectric anisotropic liquid crystal compound, a negative dielectric anisotropic liquid crystal composition including the negative dielectric anisotropic liquid crystal compound, and use of the negative dielectric anisotropic liquid crystal compound are also disclosed.

### CROSS-REFERENCE TO RELATED APPLICATION

This application claims priority of Taiwanese Patent Application No. 108118248, filed on May 27, 2019.

### FIELD

The disclosure relates to a liquid crystal compound, and more particularly to a negative dielectric anisotropic liquid crystal compound. The disclosure also relates to a process for preparing the negative dielectric anisotropic liquid crystal compound, and use of the negative dielectric anisotropic liquid crystal compound in the field of liquid crystal display.

### BACKGROUND

With the development of display technology, liquid displays have been more diversified in terms of the functions and the applications thereof. For example, portable electronic devices, such as smart phones, digital cameras, and hand-held electronic games are provided with liquid crystal screens and have characteristics of light weight and small volume, resulting in convenient portability. Miniaturization and lightweight characteristics of the portable electronic devices due to the introduction of the liquid crystal displays therein affect consumers' habit of using the portable electronic devices.

Although the technologies of the currently available thin film transistor liquid crystal display (TFT-LCD) products are relatively well-developed, display panel manufacturers continuously desire to further enhance the requirements for the display technologies. With the extensive use and reliance of the portable electronic devices, especially the smart phones, consumers desire to have portable electronic devices with improved battery endurance. For example, 80% of the electricity consumption of the smart phone is on the liquid crystal screen. Therefore, the battery endurance can be improved if the electricity consumption of the liquid crystal screen of the smart phone can be reduced. Therefore, those skilled in the art endeavor to develop a new liquid crystal material to enhance the negative dielectric anisotropy of the liquid crystal so as to reduce the driving voltage and the electricity consumption of the liquid crystal screen, thereby improving the battery endurance of the portable electronic devices.

### SUMMARY

Therefore, a first object of the disclosure is to provide a negative dielectric anisotropic liquid crystal compound having enhanced negative dielectric anisotropy.

A second object of the disclosure is to provide a process for preparing a negative dielectric anisotropic liquid crystal compound having enhanced negative dielectric anisotropy.

A third object of the disclosure is to provide a negative dielectric anisotropic liquid crystal composition which includes a negative dielectric anisotropic liquid crystal compound having enhanced negative dielectric anisotropy.

A fourth object of the disclosure is to provide a liquid crystal display having a relatively small driving voltage and a relatively low electricity consumption.

According to a first aspect of the disclosure, there is provided a negative dielectric anisotropic liquid crystal compound represented by Formula (I):

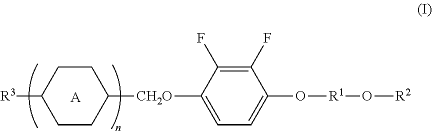

wherein

R¹ is selected from the group consisting of a C₁-C₆ alkylene group and a C₂-C₆ alkenylene group;

R² and R³ are independently selected from the group consisting of hydrogen, a C₁-C₇ alkyl group, a C₁-C₆ alkoxy group, and a C₂-C₆ alkenyl group;

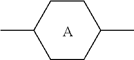

represents a member selected from the group consisting of

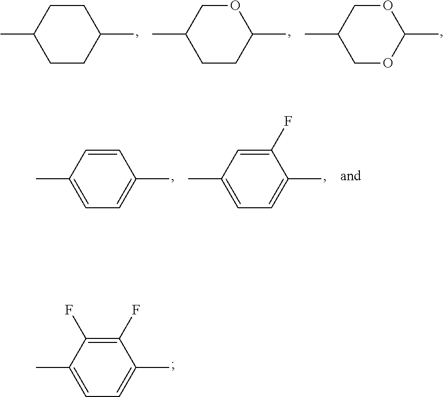

and

n is an integer ranging from 1 to 2,

with the proviso that when n is 2, two

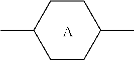

are the same or different.

According to a second aspect of the disclosure, there is provided a process for preparing a negative dielectric anisotropic liquid crystal compound, which includes the steps of:

a) subjecting a first mixture including

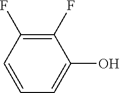

and a compound represented by X¹—R¹—O—R² to a reaction so as to form a compound represented by

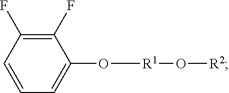

b) subjecting a second mixture including the compound represented by

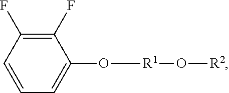

an organic lithium compound, and a borate ester compound to a reaction so as to form a compound represented by

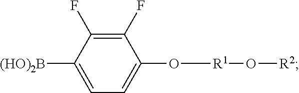

c) subjecting a third mixture including the compound represented by

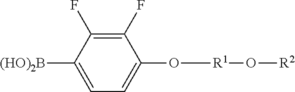

and an oxidant to a reaction so as to form a compound represented by

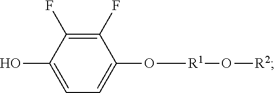

and

d) subjecting a fourth mixture including the compound represented by

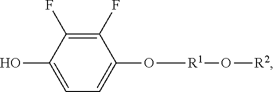

a compound represented by

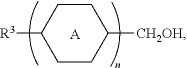

and a basic compound to a reaction so as to form a negative dielectric anisotropic liquid crystal compound represented by Formula (I),

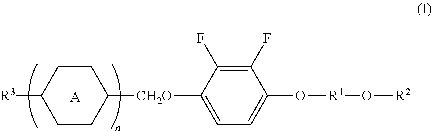

wherein

X¹ represents halogen;

R¹ is selected from the group consisting of a C₁-C₆ alkylene group and a C₂-C₆ alkenylene group;

R² and R³ are independently selected from the group consisting of hydrogen, a C₁-C₇ alkyl group, a C₁-C₆ alkoxy group, and a C₂-C₆ alkenyl group;

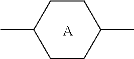

represents a member selected from the group consisting of

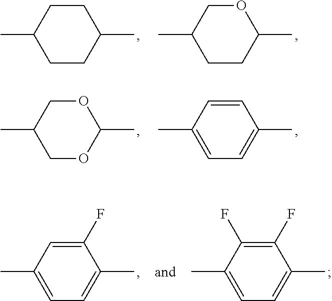

and

n is an integer ranging from 1 to 2,

with the proviso that when n is 2, two

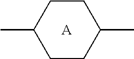

are the same or different.

According to a third aspect of the disclosure, there is provided a negative dielectric anisotropic liquid crystal composition which includes the negative dielectric anisotropic liquid crystal compound represented by Formula (I) in an amount ranging from 1 wt % to 60 wt % based on 100 wt % of the negative dielectric anisotropic liquid crystal composition.

According to a fourth aspect of the disclosure, there is provided a liquid crystal display which includes the negative dielectric anisotropic liquid crystal composition of the third aspect.

The negative dielectric anisotropic liquid crystal compound of the disclosure has a specific chemical structure as represented by Formula (I), and thus has an enhanced negative dielectricanisotropy. Therefore, a negative dielectric anisotropic liquid crystal composition including the negative dielectric anisotropic liquid crystal compound represented by Formula (I) has an enhanced negative dielectric anisotropy, and a liquid crystal display including the negative dielectric anisotropic liquid crystal composition has a relatively small driving voltage and a relatively low electricity consumption.

In addition, the negative dielectric anisotropic liquid crystal compound of the disclosure has an appropriate clearing point and an appropriate optical anisotropy.

### DETAILED DESCRIPTION

A negative dielectric anisotropic liquid crystal compound according to the disclosure is represented by Formula (I):

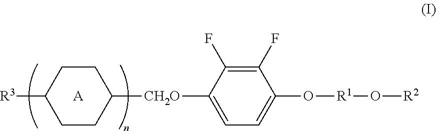

wherein

R¹ is selected from the group consisting of a C₁-C₆ alkylene group and a C₂-C₆ alkenylene group;

R² and R are independently selected from the group consisting of hydrogen, a C₁-C₇ alkyl group, a C₁-C₆ alkoxy group, and a C₂-C₆ alkenyl group;

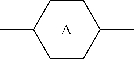

represents a member selected from the group consisting of

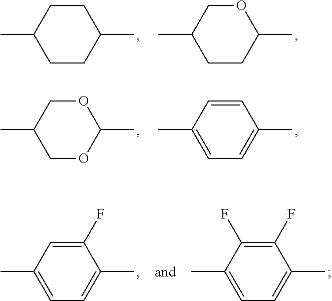

and

n is an integer ranging from 1 to 2,

with the proviso that when n is 2, two

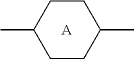

are the same or different.

In certain embodiments, R¹ is selected from the group consisting of a C₂-C₄ alkylene group and a C₂-C₄ alkenylene group.

In certain embodiments, R² and R³ are independently selected from the group consisting of a C₁-C₅ alkyl group, a C₁-C₄ alkoxy group, and a C₂-C₅ alkenyl group.

In certain embodiments,

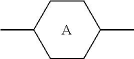

represents a member selected from the group consisting of

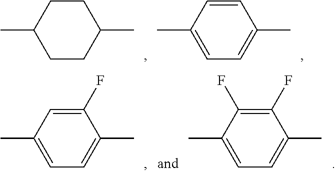

In certain embodiments, the negative dielectric anisotropic liquid crystal compound represented by Formula (I) is selected from the group consisting of compounds of Formulae (I-1) to (I-7),

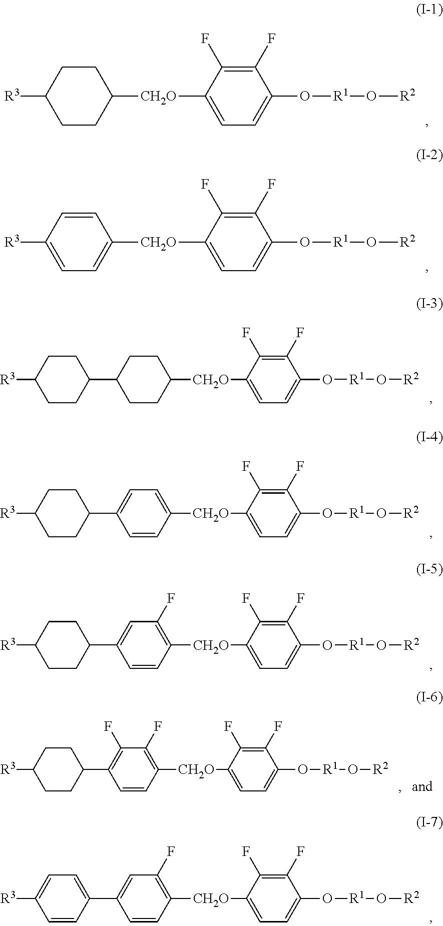

wherein

R¹ represents a C₂-C₄ alkylene group; and

R² and R³ are independently selected from the group consisting of a C₁-C₅ alkyl group and a C₂-C₅ alkenyl group.

In certain embodiments, the negative dielectric anisotropic liquid crystal compound represented by Formula (I) is selected from the group consisting of compounds of Formulae (I-1-a) to (I-7-a) and compounds of Formulae (I-1-b) to (I-7-b),

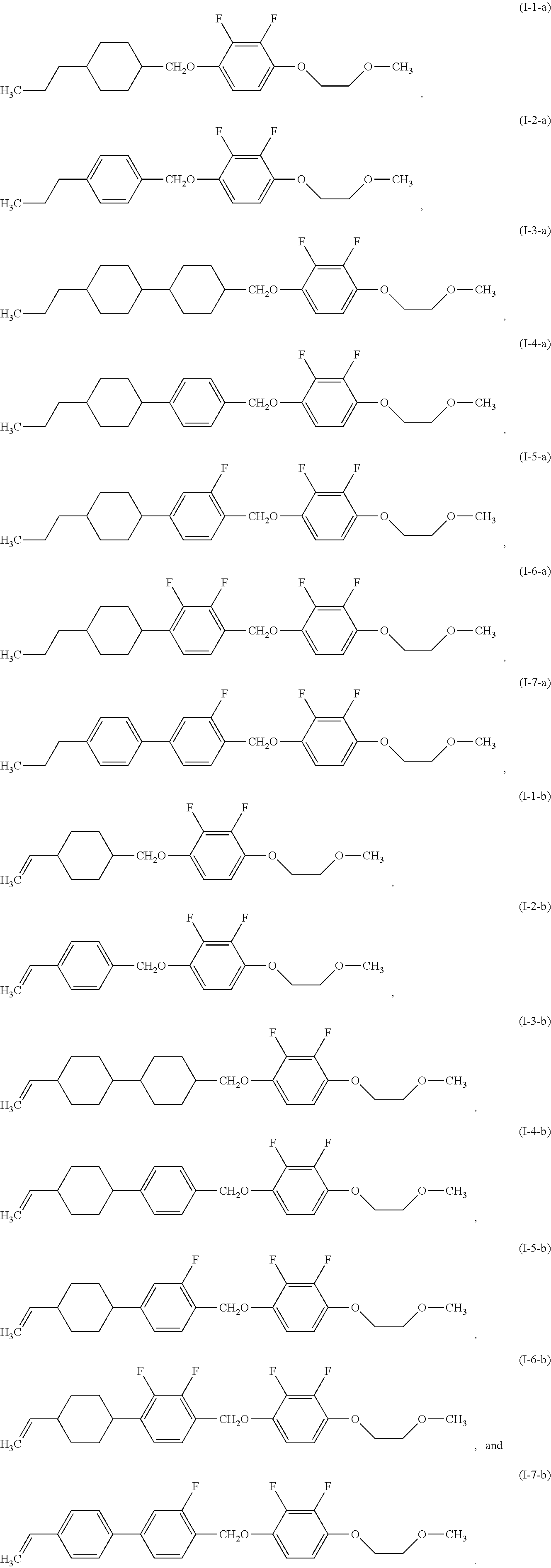

The negative dielectric anisotropic liquid crystal compound represented by Formula (I) according to the disclosure has a dielectric anisotropy (Δε) ranging from −6 to −10.

The negative dielectric anisotropic liquid crystal compound represented by Formula (I) according to the disclosure has an optical anisotropy (Δn) ranging from 0.06 to 0.15.

The negative dielectric anisotropic liquid crystal compound represented by Formula (I) according to the disclosure has a clearing point (Cp) ranging from −15° C. to 180° C.

A process for preparing a negative dielectric anisotropic liquid crystal compound according to the disclosure includes the steps of:

a) subjecting a first mixture including

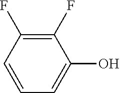

and a compound represented by X¹—R¹—O—R² to a reaction so as to form a compound represented by

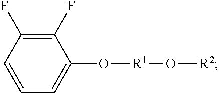

b) subjecting a second mixture including the compound represented by

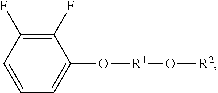

an organic lithium compound, and a borate ester compound to a reaction so as to form a compound represented by

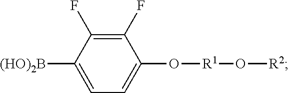

c) subjecting a third mixture including the compound represented by

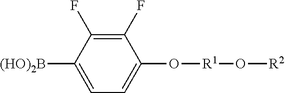

and an oxidant to a reaction so as to form a compound represented by

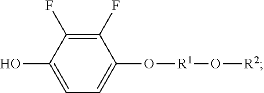

and

d) subjecting a fourth mixture including the compound represented by

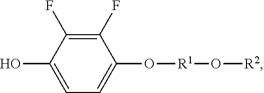

a compound represented by

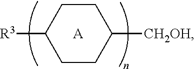

and a basic compound to a reaction so as to form a negative dielectric anisotropic liquid crystal compound represented by Formula (I),

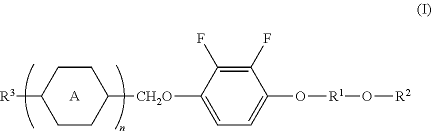

wherein

X¹ represents halogen; and

R¹, R², R³, n, and

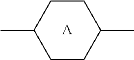

have the meanings as defined above.

In certain embodiments, in step a), the first mixture further includes a solvent and a basic agent. Examples of the solvent in step a) include, but are not limited to, polar non-protonic solvents, such as acetonitrile, dimethylformamide, dimethylacetamide, tetrahydrofuran, and toluene. The examples of the solvent in step a) may be used alone or in admixture of two or more thereof. Examples of the basic agent include, but are not limited to, inorganic basic compounds, such as sodium carbonate, potassium carbonate, cesium carbonate, potassium hydroxide, sodium hydroxide, lithium chloride, and the like; and organic basic compounds, such as triethylamine, 1,8-diazabicyclo[5.4.0]undec-7-ene, dimorpholinodiethylether, 3-(dimethylamino)-propylamine, and the like. The examples of the basic agent may be used alone or in admixture of two or more thereof.

In certain embodiments, in step b), examples of the organic lithium compound include, but are not limited to, sec-butyl lithium, n-butyl lithium, tert-butyl lithium, and lithium diisopropylamide. The examples of the organic lithium compound may be used alone or in admixture of two or more thereof. Examples of the borate ester compound include, but are not limited to, trimethyl borate, triisopropyl borate, and tributyl borate. The examples of the borate ester compound may be used alone or in admixture of two or more thereof.

In certain embodiments, in step b), the second mixture further includes a solvent. Examples of the solvent in step b) include, but are not limited to, non-protonic solvents, such as tetrahydrofuran, diethyl ether, n-hexanone, toluene, acetonitrile, and the like. The examples of the solvent in step b) may be used alone or in admixture of two or more thereof.

In certain embodiments, in step c), examples of the oxidant include, but are not limited to, hydrogen peroxide, indium oxide, cuprous oxide, zinc oxide, ferric oxide, and the like. The examples of the oxidant may be used alone orin admixture of two or more thereof.

In certain embodiments, in step d), the basic compound is selected from the group consisting of an inorganic basic compound, an organic basic compound, and the combination thereof. Examples of the inorganic basic compound include, but are not limited to, sodium carbonate, potassium carbonate, cesium carbonate, potassium hydroxide, sodium hydroxide, lithium chloride, and the like. The examples of the inorganic basic compound may be used alone or in admixture of two or more thereof. Examples of the organic basic compound include, but are not limited to, triethylamine, 1,8-diazabicyclo[5.4.0]undec-7-ene, dimorpholinodiethylether, 3-(dimethylamino)-propylamine, and the like. The examples of the organic basic compound may be used alone or in admixture of two or more thereof.

In certain embodiments, in step d), the fourth mixture further includes a solvent. Examples of the solvent in step d) include, but are not limited to, polar non-protonic solvents, such as acetonitrile, dimethylformamide, dimethylacetamide, tetrahydrofuran, and toluene. The examples of the solvent in step d) may be used alone or in admixture of two or more thereof.

A negative dielectric anisotropic liquid crystal composition according to the disclosure includes one or more of the negative dielectric anisotropic liquid crystal compound represented by Formula (I) in an amount ranging from 1 wt % to 60 wt % based on 100 wt % of the negative dielectric anisotropic liquid crystal composition. In certain embodiments, the amount of the negative dielectric anisotropic liquid crystal compound represented by Formula (I) included in the negative dielectric anisotropic liquid crystal composition is in a range from 3 wt % to 45 wt % based on 100 wt % of the negative dielectric anisotropic liquid crystal composition. In certain embodiments, the amount of the negative dielectric anisotropic liquid crystal compound represented by Formula (I) included in the negative dielectric anisotropic liquid crystal composition is in a range from 5 wt % to 30 wt % based on 100 wt % of the negative dielectric anisotropic liquid crystal composition.

A liquid crystal display according to the disclosure includes the negative dielectric anisotropic liquid crystal composition described above. Examples of the liquid crystal display, include, but are not limited to, twisted nematic (TN) mode liquid crystal display, advanced super dimension switch (ADS) mode liquid crystal display, vertical alignment (VA) mode liquid crystal display, polymer-stabilized vertical alignment (PS-VA) mode liquid crystal display, fringe-field switching (FFS) mode liquid crystal display, and in-plane switching (IPS) mode liquid crystal display.

Examples of the disclosure will be described hereinafter. It is to be understood that these examples are exemplary and explanatory and should not be construed as a limitation to the disclosure.

### Example 1: Preparation of a Negative Dielectric Anisotropic Liquid Crystal Compound Represented by Formula (I-1-a)

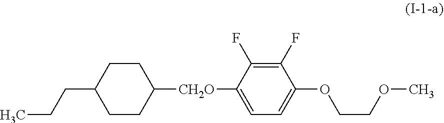

A negative dielectric anisotropic liquid crystal compound represented by Formula (I-1-a) was prepared according to a reaction scheme shown below:

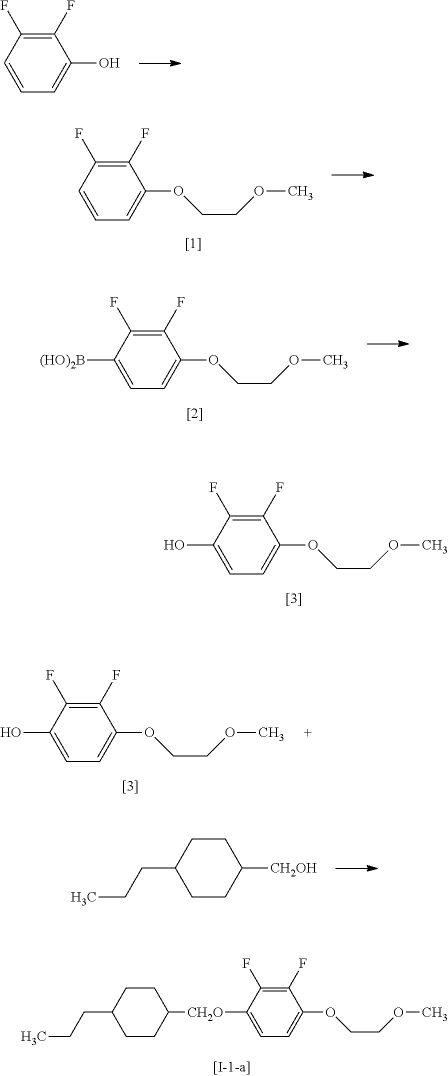

2,3-difluorophenol (26 g), 2-bromoethyl methyl ether (30 g), potassium carbonate (31 g), and acetonitrile (200 ml) were mixed to form a first mixture. The first mixture was heated to 70° C., followed by stirring under reflux for 8 hours to obtain a crude product. The crude product was subjected to distillation at normal pressure to evaporate acetonitrile from the crude product, and was then added into toluene (200 ml), followed by washing with deionized water four times to obtain a compound represented by Formula [1] (38 g) as shown in the reaction scheme above.

The compound represented by Formula [1] (38 g) was dissolved in tetrahydrofuran (300 ml), followed by cooling to −78° C., mixing with n-butyl lithium (88 ml) under stirring for 1 hour, and then mixing with tributyl borate (50 g) to form a second mixture. The temperature of the second mixture was raised naturally to room temperature (about 25° C.), followed by stirring the second mixture at room temperature for 6 hours to obtain a crude product. An aqueous hydrochloric acid solution (200 ml, obtained by mixing hydrochloric acid (50 ml, concentration: 36.5%) with water (150 ml)) was added to the crude product, followed by stirring for 0.5 hour and extraction to obtain an organic layer containing a compound represented by Formula [2] as shown in the reaction scheme above.

The organic layer was mixed with hydrogen peroxide (30 ml, concentration: 30%) to form a third mixture. The third mixture was stirred at room temperature (about 25° C.) for 2 hours to obtain a crude product. The crude product was subjected to distillation at normal pressure to remove tetrahydrofuran therefrom, followed by extraction twice with dichloromethane. Two organic layers obtained by the extractions were combined to form a combination. Dichloromethane was evaporated from the combination, followed by recrystallization with ethanol to obtain a compound represented by Formula [3] (32 g) as shown in the reaction scheme above.

The compound represented by Formula [3] (32 g), 4-propylcyclohexylmethanol (36 g), potassium carbonate (24.8 g), and acetonitrile (200 ml) were mixed to form a fourth mixture. The fourth mixture was heated to 70° C., followed by stirring under reflux for 8 hours to obtain a crude product. The crude product was subjected to distillation at normal pressure to evaporate acetonitrile from the crude product, and was then added into toluene (200 ml), followed by washing four times with deionized water to obtain a solid material. The solid material was recrystallized twice with ethanol to obtain a negative dielectric anisotropic liquid crystal compound represented by Formula (I-1-a) (36 g, gas chromatography (GC) purity: 99.9%) shown above.

### Example 2: Preparation of a Negative Dielectric Anisotropic Liquid Crystal Compound Represented by Formula (I-2-a)

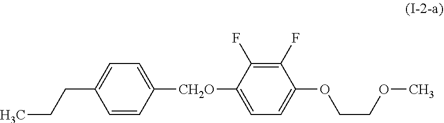

A negative dielectric anisotropic liquid crystal compound represented by Formula (I-2-a) was prepared according to a reaction scheme shown below:

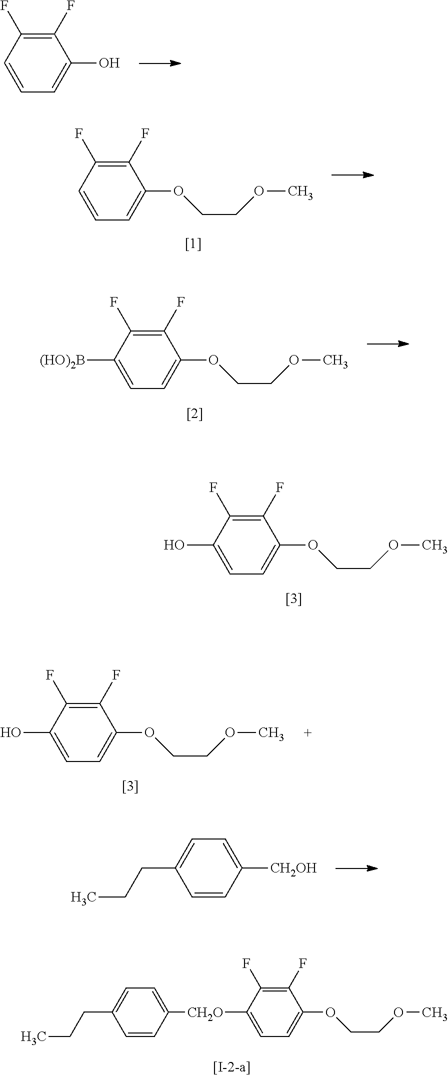

A compound represented by Formula [3] shown in the reaction scheme above was prepared according to the procedures described in Example 1.

The compound represented by Formula [3] (32 g), p-propylbenzyl alcohol (35.8 g), potassium carbonate (24.8 g), and acetonitrile (200 ml) were mixed to form a mixture. The mixture was heated to 70° C., followed by stirring under reflux for 8 hours to obtain a crude product. The crude product was subjected to distillation at normal pressure to evaporate acetonitrile from the crude product, and was then added into toluene (200 ml), followed by washing four times with deionized water to obtain a solid material. The solid material was recrystallized twice with ethanol to obtain a negative dielectric anisotropic liquid crystal compound represented by Formula (I-2-a) (36 g, GC purity: 99.9%) shown above.

### Example 3: Preparation of a Negative Dielectric Anisotropic Liquid Crystal Compound Represented by Formula (I-3-a)

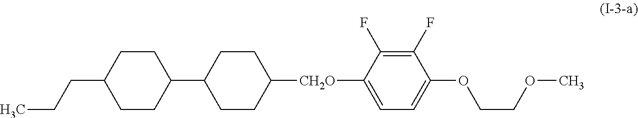

A negative dielectric anisotropic liquid crystal compound represented by Formula (I-3-a) was prepared according to a reaction scheme shown below:

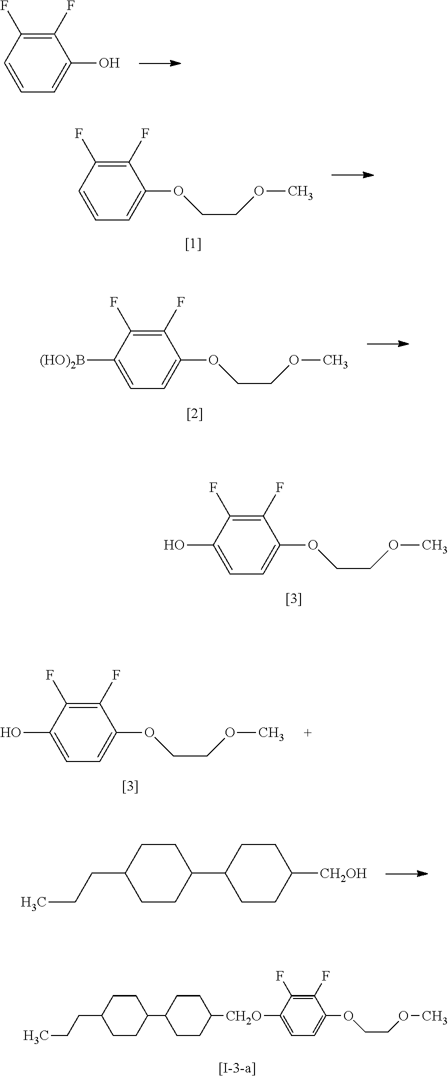

A compound represented by Formula [3] shown in the reaction scheme above was prepared according to the procedures described in Example 1.

The compound represented by Formula [3] (32 g), 4-propylcyclohexylmethanol (60 g), potassium carbonate (24.8 g), and acetonitrile (200 ml) were mixed to form a mixture. The mixture was heated to 70° C., followed by stirring under reflux for 8 hours to obtain a crude product. The crude product was subjected to distillation at normal pressure to evaporate acetonitrile from the crude product, and was then added into toluene (200 ml), followed by washing four times with deionized water to obtain a solid material. The solid material was recrystallized twice with ethanol to obtain a negative dielectric anisotropic liquid crystal compound represented by Formula (I-3-a) (42 g, GC purity: 99.9%) shown above.

### Example 4: Preparation of a Negative Dielectric Anisotropic Liquid Crystal Compound Represented by Formula (I-4-a)

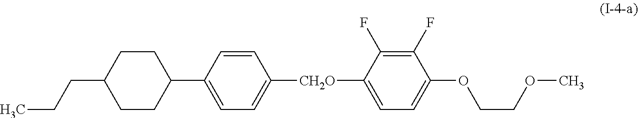

A negative dielectric anisotropic liquid crystal compound represented by Formula (I-4-a) was prepared according to a reaction scheme shown below:

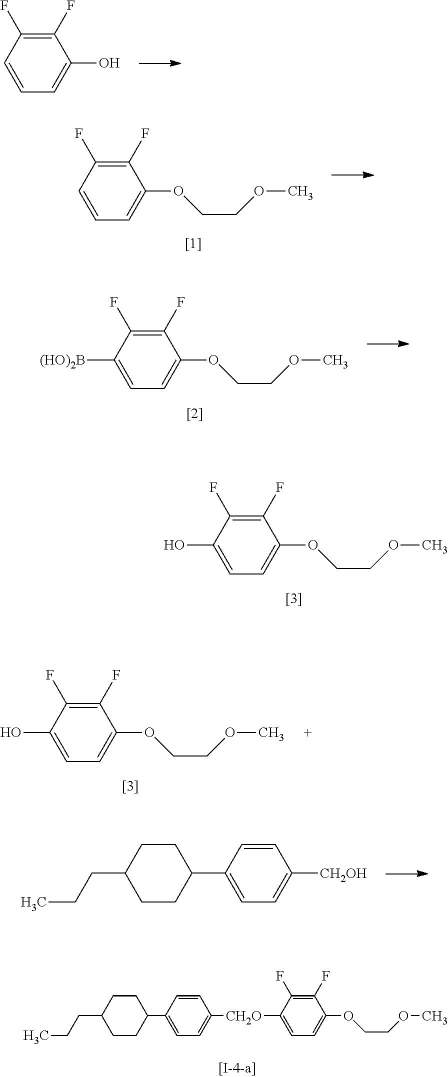

A compound represented by Formula [3] shown in the reaction scheme above was prepared according to the procedures described in Example 1.

The compound represented by Formula [3] (32 g), p-propylcyclohexylbenzyl alcohol (50 g), potassium carbonate (24.9 g), and acetonitrile (200 ml) were mixed to forma mixture. The mixture was heated to 70° C., followed by stirring under reflux for 8 hours to obtain a crude product. The crude product was subjected to distillation at normal pressure to evaporate acetonitrile from the crude product, and was then added into toluene (200 ml), followed by washing four times with deionized water to obtain a solid material. The solid material was recrystallized twice with ethanol to obtain a negative dielectric anisotropic liquid crystal compound represented by Formula (I-4-a) (41 g, GC purity: 99.9%) shown above.

### Comparative Example 1

A liquid crystal compound commercially available from Yantai Derun Liquid Crystal Materials Co., Ltd., China, and having a formula shown below was used as Comparative Example 1.

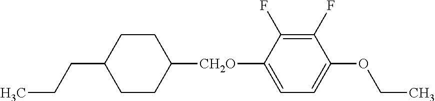

### Comparative Example 2

A liquid crystal compound commercially available from Yantai Derun Liquid Crystal Materials Co., Ltd., China, and having a formula shown below was used as Comparative Example 2.

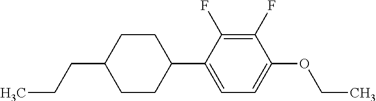 [SMILES: CCCC1CCC(c2ccc(OCC)c(F)c2F)CC1]

### Comparative Example 3

A liquid crystal compound commercially available from Yantai Derun Liquid Crystal Materials Co., Ltd., China, and having a formula shown below was used as Comparative Example 3.

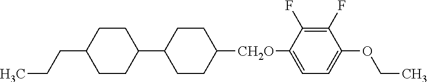

### Comparative Example 4

A liquid crystal compound commercially available from Yantai Derun Liquid Crystal Materials Co., Ltd., China, and having a formula shown below was used as Comparative Example 4.

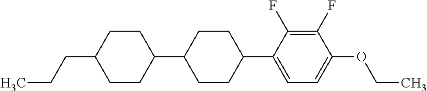 [SMILES: CCCC1CCC(C2CCC(c3ccc(OCC)c(F)c3F)CC2)CC1]

### Comparative Example 5

A liquid crystal compound commercially available from Yantai Derun Liquid Crystal Materials Co., Ltd., China, and having a formula shown below was used as Comparative Example 5.

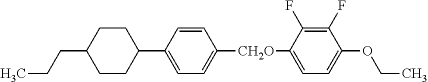

### Comparative Example 6

A liquid crystal compound commercially available from Yantai Derun Liquid Crystal Materials Co., Ltd., China, and having a formula shown below was used as Comparative Example 6.

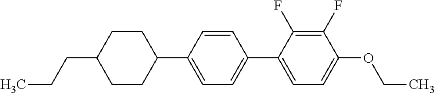 [SMILES: CCCC1CCC(c2ccc(-c3ccc(OCC)c(F)c3F)cc2)CC1]

Property Evaluation:

The negative dielectric anisotropic liquid crystal compounds of Examples 1, 3, and 4 and the liquid crystal compounds of Comparative Examples 1 to 6 were evaluated in terms of the properties described below. The results are shown in Tables 1 to 3.

1. Clearing point (Cp, ° C.):

A liquid crystal compound to be tested was observed using a microscope while being heated using a heater. The temperature at which the liquid crystal compound transformed from a liquid crystal phase to a liquid phase was recorded as a clearing point of the liquid crystal compound.

2. Optical anisotropy (Δn):

A refractive index of ordinary light (no) and a refractive index of extraordinary light (ne) of a liquid crystal compound to be tested was measured using an Abbe refractometer (Manufacturer: Atago Co., Ltd., Japan) at a wavelength of 589 nm and at a temperature of 25° C. The optical anisotropy was calculated according to a formula as below:

Δn=ne−no.

3. Dielectric Anisotropy (Δε):

A liquid crystal compound to be tested was placed in a 20 μm parallel-aligned nematic (PAN) cell in which no chiral dopant was added. Measurement was implemented using a measurement instrument (Manufacturer: INSTEC; Model: ALCT-IR1) at a temperature of 25° C. and at a voltage of 10 V. The dielectric anisotropy was calculated according to a formula as below.

Δε=ε∥−ε⊥,

wherein

ε∥ is a dielectric constant parallel to a molecular axis of the liquid crystal compound; and

ε⊥ is a dielectric constant transverse to a molecular axis of the liquid crystal compound.

TABLE 1

| | Liquid crystal compound | Δε | Δn | Cp (° C.) |
|---|---|---|---|---|
| Example 1 | Formula (I-1-a) | −9.2 | 0.065 | −13.3 |
| | 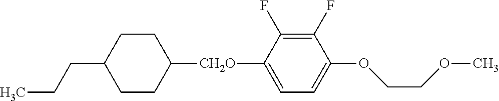 | | | |
| Comparative Example 1 | 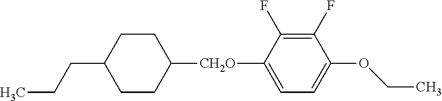 | −8.0 | 0.067 | −11.8 |
| Comparative Example 2 | 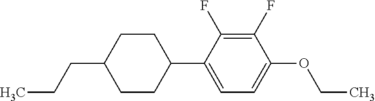 [SMILES: CCCC1CCC(c2ccc(OCC)c(F)c2F)CC1] | −5.5 | 0.068 | −7.8 |

As shown in Table 1, the negative dielectric anisotropic liquid crystal compound represented by Formula (I-1-a) of Example 1 has an absolute value of the dielectric anisotropy larger than those of the liquid crystal compounds of Comparative Examples 1 and 2.

TABLE 2

| | Liquid crystal compound | Δε | Δn | Cp (° C.) |
|---|---|---|---|---|
| Example 3 | Formula (I-3-a) | −9.4 | 0.099 | 125.3 |
| | 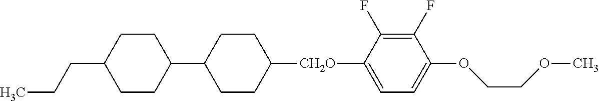 | | | |
| Comparative Example 3 | 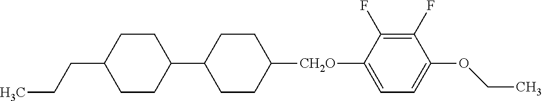 | −8.2 | 0.117 | 137.8 |
| Comparative Example 4 | 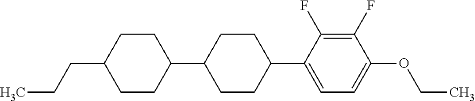 [SMILES: CCCC1CCC(C2CCC(c3ccc(OCC)c(F)c3F)CC2)CC1] | −5.8 | 0.116 | 173.5 |

As shown in Table 2, the negative dielectric anisotropic liquid crystal compound represented by Formula (I-3-a) of Example 3 has an absolute value of the dielectric anisotropy larger than those of the liquid crystal compounds of Comparative Examples 3 and 4.

TABLE 3

| | Liquid crystal compound | Δε | Δn | Cp (° C.) |
|---|---|---|---|---|
| Example 4 | Formula (I-4-a) | −9.7 | 0.143 | 116.3 |
| | 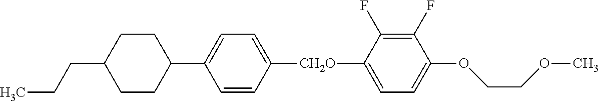 | | | |
| Comparative Example 5 | 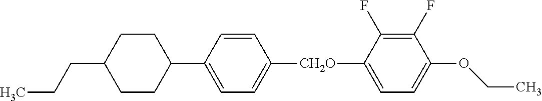 | −8.5 | 0.156 | 125.8 |
| Comparative Example 6 | 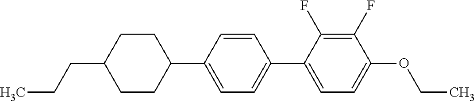 [SMILES: CCCC1CCC(c2ccc(-c3ccc(OCC)c(F)c3F)cc2)CC1] | −5.5 | 0.183 | 165.6 |

As shown in Table 3, the negative dielectric anisotropic liquid crystal compound represented by Formula (I-4-a) of Example 3 has an absolute value of the dielectric anisotropy larger than those of the liquid crystal compounds of Comparative Examples 5 and 6.

The results shown in Tables 1 to 3 confirm that the negative dielectric anisotropic liquid crystal compound according to the disclosure has superior negative dielectric anisotropy. Therefore, a negative dielectric anisotropic liquid crystal composition including the negative dielectric anisotropic liquid crystal compound according to the disclosure can have superior negative dielectric anisotropy, and a liquid crystal display including the negative dielectric anisotropic liquid crystal composition can have a reduced driving voltage and a reduced electricity consumption.

In addition, since a negative dielectric anisotropic liquid crystal composition including the negative dielectric anisotropic liquid crystal compound according to the disclosure can have superior negative dielectric anisotropy, the amount of a polar liquid crystal compound used in the negative dielectric anisotropic liquid crystal compound can be reduced such that a rotational viscosity of the negative dielectric anisotropic liquid crystal compound can be effectively reduced, so as to enhance a response time of a liquid crystal display made thereby.

In view of the aforesaid, the negative dielectric anisotropic liquid crystal compound according to the disclosure has superior negative dielectric anisotropy. Therefore, a negative dielectric anisotropic liquid crystal composition including the negative dielectric anisotropic liquid crystal compound according to the disclosure can have superior negative dielectric anisotropy, and a liquid crystal display including the negative dielectric anisotropic liquid crystal composition can have a reduced driving voltage and a reduced electricity consumption. In addition, the negative dielectric anisotropic liquid crystal compound according to the disclosure has an appropriate clearing point and an appropriate optical anisotropy.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A negative dielectric anisotropic liquid crystal compound represented by Formula (I): 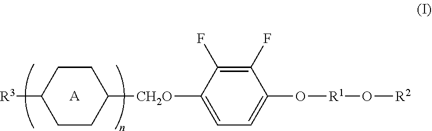
wherein
R¹ is selected from the group consisting of a C₁-C₆ alkylene group and a C₂-C₆ alkenylene group;
R² and R³ are independently selected from the group consisting of hydrogen, a C₁-C₇ alkyl group, a C₁-C₆ alkoxy group, and a C₂-C₆ alkenyl group; 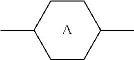
represents a member selected from the group consisting of 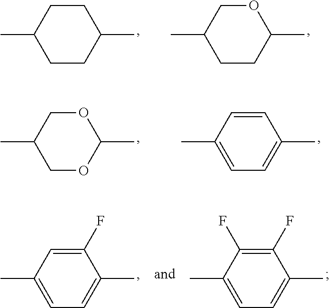
and
n is an integer ranging from 1 to 2,
with the proviso that when n is 2, two 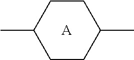
are the same or different.

2. The negative dielectric anisotropic liquid crystal compound as claimed in claim 1, wherein R¹ is selected from the group consisting of a C₂-C₄ alkylene group and a C₂-C₄ alkenylene group, and R² and R³ are independently selected from the group consisting of a C₁-C₅ alkyl group, a C₁-C₄ alkoxy group, and a C₂-C₅ alkenyl group.

3. The negative dielectric anisotropic liquid crystal compound as claimed in claim 1, wherein 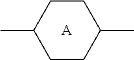
represents a member selected from the group consisting of

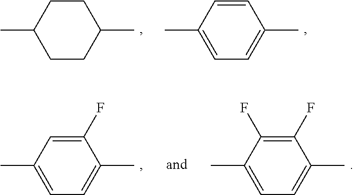

4. The negative dielectric anisotropic liquid crystal compound as claimed in claim 1, which is selected from the group consisting of compounds of Formulae (I-1) to (I-7), 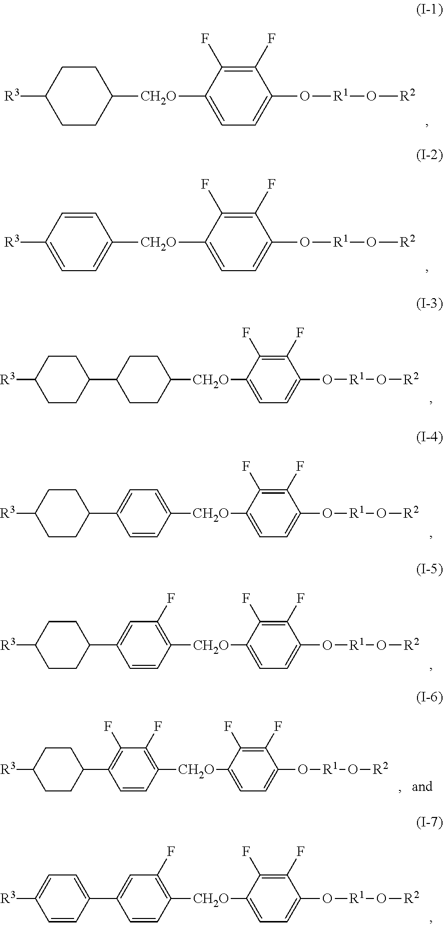
wherein
R¹ represents a C₂-C₄ alkylene group; and
R² and R³ are independently selected from the group consisting of a C₁-C₅ alkyl group and a C₂-C₅ alkenyl group.

5. The negative dielectric anisotropic liquid crystal compound as claimed in claim 4, which is selected from the group consisting of compounds of Formulae (I-1-a) to (I-7-a) and compounds of Formulae (I-1-b) to (I-7-b),

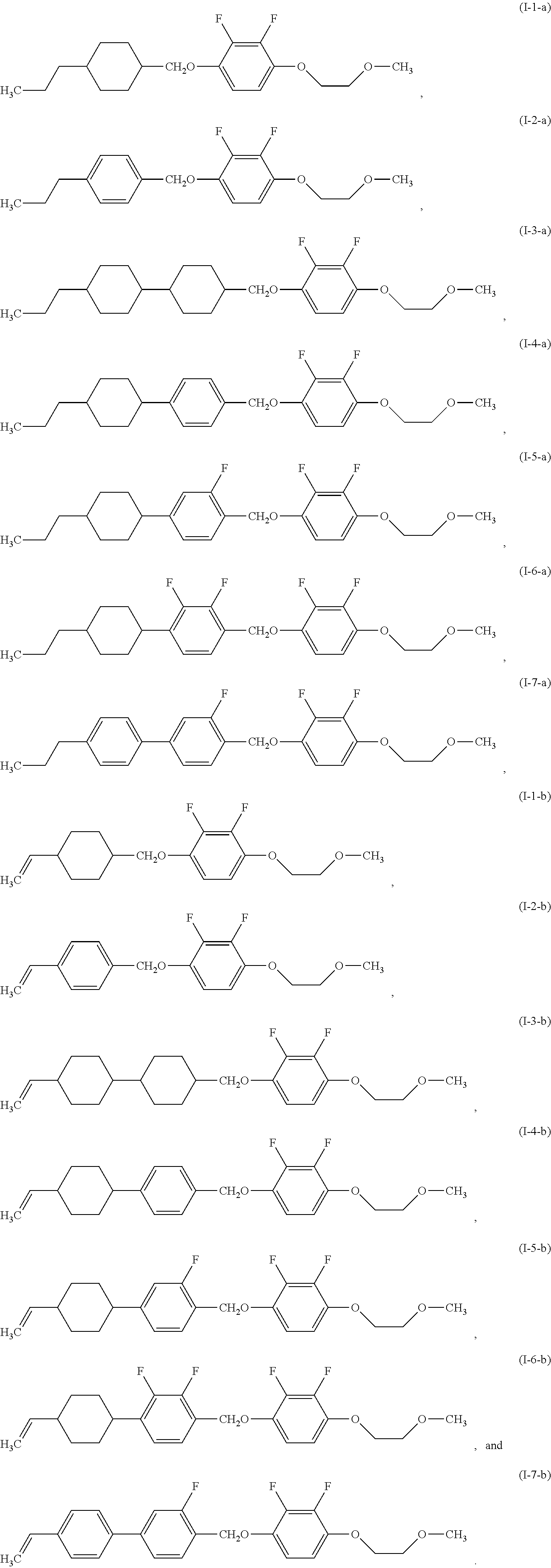

6. A process for preparing a negative dielectric anisotropic liquid crystal compound, comprising the steps of:
a) subjecting a first mixture including 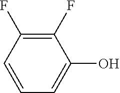
and a compound represented by X¹—R¹—O—R² to a reaction so as to form a compound represented by 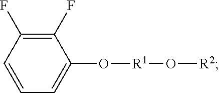
b) subjecting a second mixture including the compound represented by 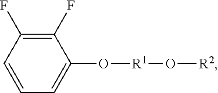
an organic lithium compound, and a borate ester compound to a reaction so as to form a compound represented by 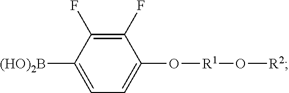
c) subjecting a third mixture including the compound represented by 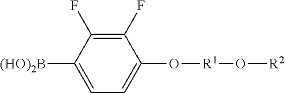
and an oxidant to a reaction so as to form a compound represented by 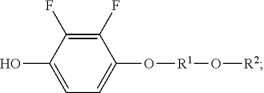
and
d) subjecting a fourth mixture including the compound represented by 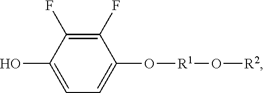
a compound represented by 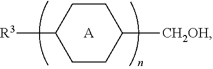
and a basic compound to a reaction so as to form a negative dielectric anisotropic liquid crystal compound represented by Formula (I), 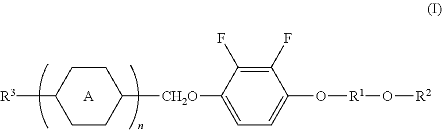
wherein
X¹ represents halogen;
R¹ is selected from the group consisting of a C₁-C₆ alkylene group and a C₂-C₆ alkenylene group;
R² and R are independently selected from the group consisting of hydrogen, a C₁-C₇ alkyl group, a C₁-C₆ alkoxy group, and a C₂-C₆ alkenyl group; 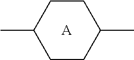
represents a member selected from the group consisting of 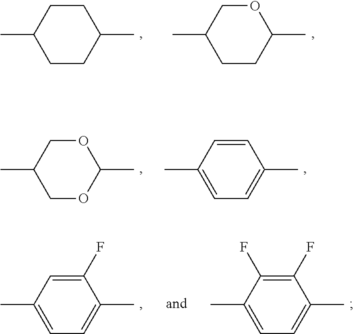
and
n is an integer ranging from 1 to 2,
with the proviso that when n is 2, two 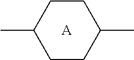
are the same or different.

7. The process as claimed in claim 6, wherein in step b), the organic lithium compound is selected from the group consisting of sec-butyl lithium, n-butyl lithium, tert-butyl lithium, lithium diisopropylamide, and combinations thereof; and the borate ester compound is selected from the group consisting of trimethylborate, triisopropylborate, tributylborate, and combinations thereof.

8. The process as claimed in claim 6, wherein in step d), the basic compound is selected from the group consisting of an inorganic basic compound, an organic basic compound, and the combination thereof.

9. A negative dielectric anisotropic liquid crystal composition, comprising the negative dielectric anisotropic liquid crystal compound as claimed in claim 1 in an amount ranging from 1 wt % to 60 wt % based on 100 wt % of the negative dielectric anisotropic liquid crystal composition.

10. A liquid crystal display, comprising the negative dielectric anisotropic liquid crystal composition as claimed in claim 9.
